(19) United States
(12) Patent Application Publication
(10) Pub. No.: US 2020/0316510 A1
(43) Pub. Date: Oct. 8, 2020

(54) Single-Stage Filtration System

(71) Applicant: Tianjin Tianchuang Best Pure Environmental Science And Technology Co., Ltd., Tianjin (CN)

(72) Inventor: Enyu Wei, TIANJIN (CN)

(73) Assignee: Tianjin Tianchuang Best Pure Environmental Science And Technology Co., Ltd., Tianjin (CN)

(21) Appl. No.: 16/374,566

(22) Filed: Apr. 3, 2019

(51) Int. Cl. B01D 46/00

(52) U.S. Cl. CPC B01D 46/0005; B01D 35/306

(57) ABSTRACT

The Invention relates to a single-stage filtration system, including a joint and a filter element, wherein the joint is mounted on the filter element, a joint body is provided thereon with a water inlet cavity I and a water outlet cavity, one end of the water inlet cavity is a water inlet joint, the water inlet joint is provided thereon with a water inlet boss, the water inlet boss is cylindrical, a water inlet hole is at the center of the water inlet boss, one end of the water outlet cavity is connected with the water outlet joint, the water outlet cavity is located at an eccentricity of the water outlet boss, one end of the water outlet cavity is connected with the water outlet joint, and the other end of the water outlet cavity is on the water outlet boss. The Invention improves the wear of a connector caused by the repeated disassembly of a filter through the setting of the single-stage filtration system, and ensures the sealing performance of the filtration system.

### TECHNICAL FIELD

The Invention relates to a single-stage filtration system.

### TECHNICAL BACKGROUND

Currently, a single-stage filtration system is a threaded upper and lower opening-closing end cover filtration system. When a filter bottle is removed, it will appear that a bottle body needs to be unscrewed. When the bottle body and an end cover are screwed too much, a compression angle of the bottle body is tight and it is difficult to carry out disassembly.

### SUMMARY

In order to overcome the deficiencies of the prior art, the Invention provides a single-stage filtration system.

In order to solve the above problems, the technical solution adopted by the Invention is:

A single-stage filtration system comprises a joint and a filter element, wherein the joint is mounted on the filter element, the joint comprises a joint body, a water inlet sealing ring, a water inlet cover plate, a water inlet clamp, a water outlet sealing ring, a water outlet cover plate, a water outlet clamp, a filter element inlet water sealing ring and a filter element water outlet sealing ring, the joint body comprises an inlet water cavity I, a water outlet cavity, a water inlet joint, a water outlet joint, a connecting flange, a water inlet boss, a water outlet boss, a hanging piece, a reinforcing rib, the filter element comprises an end cover, a filter element body, a carbon rod cover, a carbon rod bottom and a carbon rod, the joint body is provided thereon with the water inlet cavity I and the water outlet cavity, one end of the water inlet cavity is the water inlet joint, the water inlet joint is provided thereon with the water inlet boss, the water inlet boss is cylindrical, and the water inlet hole is at the center of the water inlet boss, one end of the water outlet cavity is connected with the water outlet joint, the water outlet cavity is located at an eccentricity of the water outlet boss, one end of the water outlet cavity is connected with the water outlet joint, and the other end of the water outlet cavity is on the water outlet boss, the water outlet boss is cylindrical, the water inlet joint is provided therein with a water pipe hole I, a sealing ring hole I and a cover plate hole I, the water pipe hole I cooperates with a water pipe, the water inlet sealing ring is mounted in the sealing ring hole I, the water inlet cover plate is mounted in the cover plate hole I, the water outlet joint is on the other side of the joint body, the water outlet joint is provided thereon with a water pipe hole II, a sealing ring hole II, and a cover plate hole II, the water pipe hole II cooperates with the water pipe, the water outlet sealing ring is mounted in the sealing ring hole II, the water outlet cover plate is mounted in the cover plate hole II, the bottom of the joint body is provided with two connecting flanges, the connecting flange is a C-shaped structure, a rectangular opening is provided above the connecting flange, the connecting flange cooperates with the end cover of the filter element, the water inlet boss is at the center of the filter element body, the water inlet boss is formed into a column-shaped structure, one end of the water inlet boss is connected with the joint body, and the other end of the water inlet boss is connected with the water outlet boss, the water inlet boss is provided therein with a water inlet passage and a water outlet passage, the water outlet passage is located at the center of the water inlet boss, one side of the water outlet passage is the water inlet passage, the water inlet sealing ring is mounted on the water inlet boss, the water outlet boss is at the lower portion of the filter element body, the water outlet sealing ring is mounted on the water outlet boss, the hanging piece is located at the rear portion of the joint, the hanging piece is provided thereon with four bosses, the four bosses are on the rear side of the hanging piece, the four bosses are provided thereon with four through holes, the carbon rod cover is located at the upper end of the inner portion of the filter element body, the carbon rod cover consists of a water inlet end and a water outlet end, the water inlet end is an annular cylinder body, the inner cavity of the carbon rod cover cooperates with the water outlet boss, and the other end of the carbon rod cover is the water outlet end, the carbon rod is located at one end of the filter element body and connected with the carbon rod cover, and the other end of the carbon rod is connected with a carbon rod bottom.

Preferably, the water inlet boss is provided thereon with a water inlet boss ring groove, and the water inlet sealing ring is mounted on the water inlet boss ring groove.

Preferably, the water outlet boss is provided thereon with a water outlet boss ring groove, and the water outlet sealing ring is mounted on the water outlet boss ring groove.

Preferably, the top of the end cover has a flange, a central hole, a water inlet cavity II, a water inlet hole, and a stop port, one end of the flange is located at the top of the end cover, and the other end of the flange is located at the center of the end cover, the connecting flange cooperates with the flange, the central hole is located at the center of the end cover, an inner circle of the central hole cooperates with an outer circle of the carbon rod, the water inlet cavity II cooperates with the water outlet boss, the water inlet hole is located at the bottom of the water inlet cavity II, the stop port has a concave structure, and a convex stop port in a barrel-shaped structure is above the filter element body, wherein the stop port and the convex stop port are welded.

Preferably, the water inlet holes are arranged and distributed in a circular shape in the outer circle of the central hole.

Preferably, the water inlet cavity is L-shaped.

Preferably, the water outlet cavity is L-shaped.

Preferably, a reinforcing rib is provided between the hanging piece and the joint.

Preferably, the filter element body is provided with a connecting rib position underneath, and the carbon rod bottom is mounted on the connecting rib position.

Because the above technical solution is adopted, compared with the prior art, the Invention improves the wear of a connector caused by the repeated disassembly of a filter through the setting of the single-stage filtration system, and ensures the sealing performance of the filtration system.

The Invention will be further described below in conjunction with the drawings and embodiments.

### BRIEF DESCRIPTION OF DRAWINGS

FIG. 1 is a front elevational view of a single-stage filtration system of the Invention.

FIG. 2 is a front cross-sectional view of a single-stage filtration system of the Invention.

FIG. 3 is a rear view of a single-stage filtration system of the Invention.

FIG. 4 is a front cross-sectional view of a joint of a single-stage filtration system of the Invention.

FIG. 5 is an upward view of a joint of a single-stage filtration system of the Invention.

FIG. 6 is an axial view of a joint of a single-stage filtration system of the Invention.

FIG. 7 is a front cross-sectional view of an end cover of a single-stage filtration system of the Invention.

FIG. 8 is a top view of an end cover of a single-stage filtration system of the Invention.

FIG. 9 is a partial cross-sectional view of a water inlet joint of a filter element of a single-stage filtration system of the Invention.

FIG. 10 is a partial cross-sectional view of a water outlet joint of a filter element of a single-stage filtration system of the Invention.

FIG. 11 is a partial axial view of a filter element of a single-stage filtration system of the Invention.

In the drawings: 1: Joint, 11: Joint Body, 11a: Connecting Flange, 11b: Rectangular Opening, 111: Water Inlet Cavity I, 112: Water Outlet Cavity, 113: Water Inlet Joint, 113a: Water Pipe Hole I, 113b: Sealing Ring Hole I, 113c: Cover Plate Hole I, 114: Water Outlet Joint, 114a: Water Pipe Hole II, 114b: Sealing Ring Hole II, 114c: Cover Plate Hole II, 116: Water Inlet Boss, 116a: Water Inlet Hole, 116b: Water Inlet Boss Ring Groove, 117: Water Outlet Boss, 117a: Water Outlet Boss Ring Groove, 118: Hanging Piece, 118a: Boss, 118b: Through Hole, 119: Reinforcing Rib, 12: Water Inlet Seal Ring, 13: Water Inlet Cover Plate, 14: Water Inlet Clamp, 15: Water Outlet Sealing Ring, 16: Water Outlet Cover Plate, 17: Water Outlet Clamp, 18: Filter Element Water Inlet Sealing Ring, 19: Filter Element Water Outlet Sealing Ring, 2: Filter Element, 21: End Cover, 211: Flange, 212: Central Hole, 213: Water Inlet Cavity II, 214: Water Inlet Hole, 215: Stop Port, 22: Filter Element Body, 22a: Convex Stop Port, 23: Carbon Rod Cover, 23a: Water Inlet End, 23b: Water Outlet End, 24: Carbon Rod Bottom, 25: Carbon Rod.

### DETAILED DESCRIPTION

### EXAMPLE

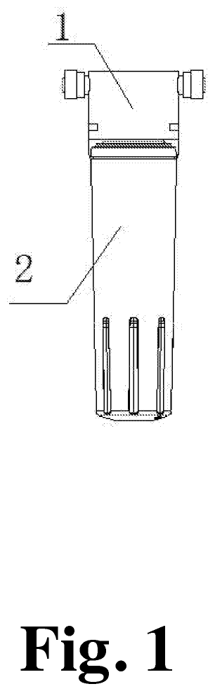

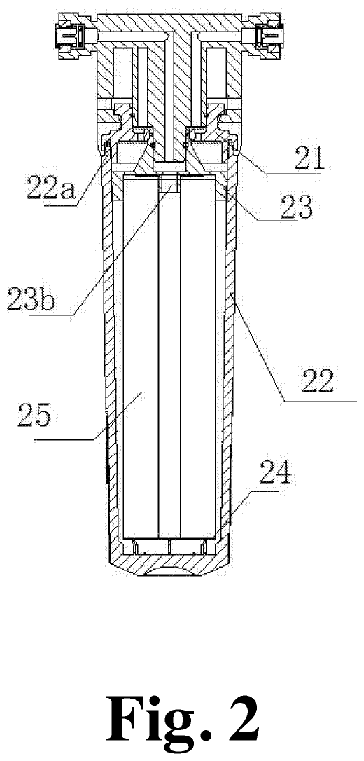

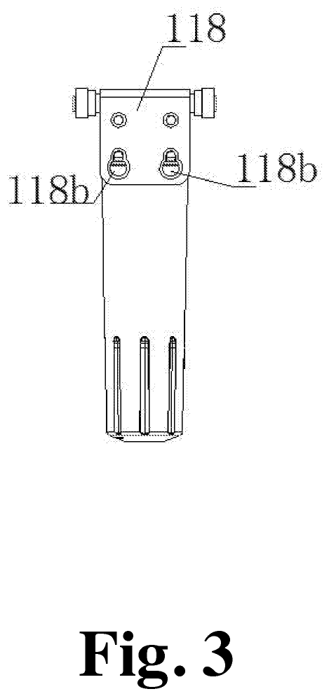

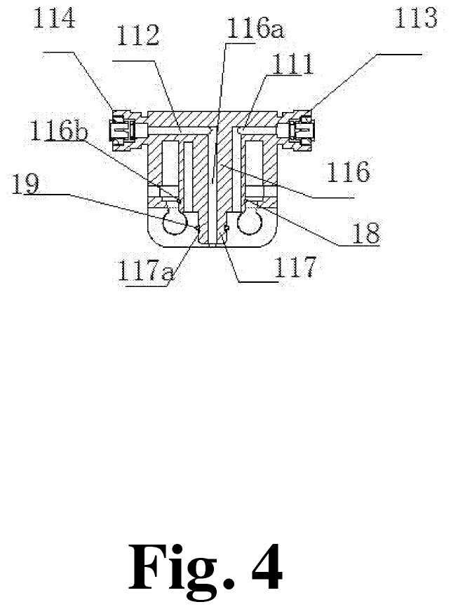

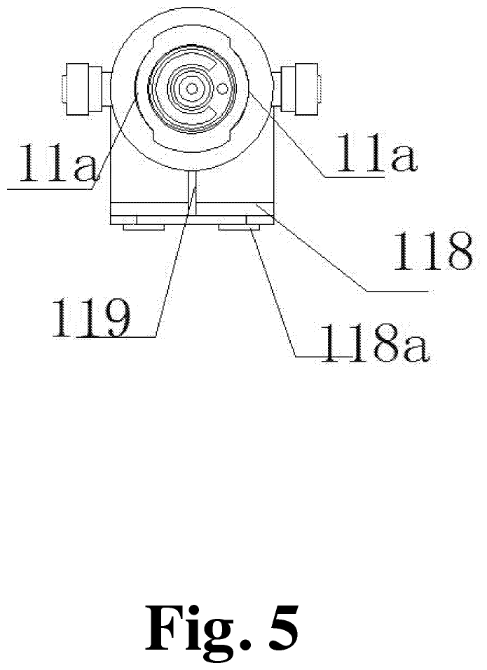

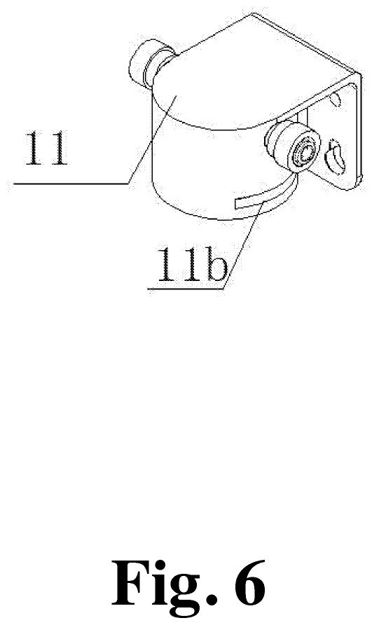

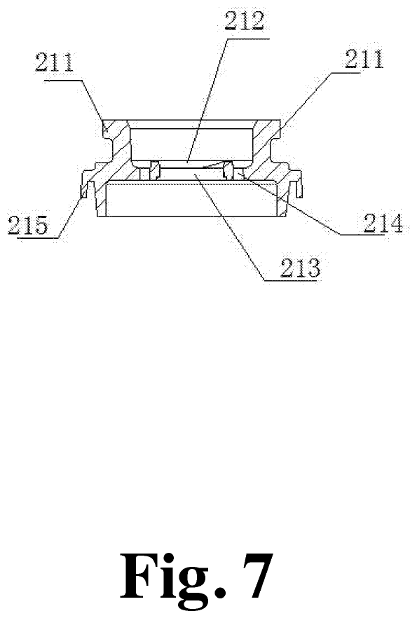

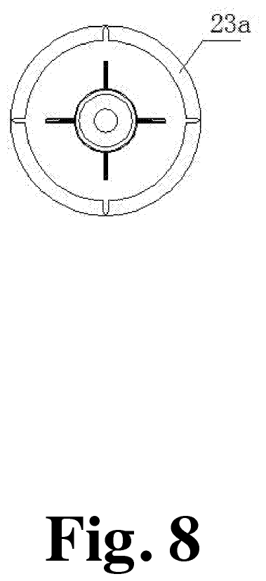

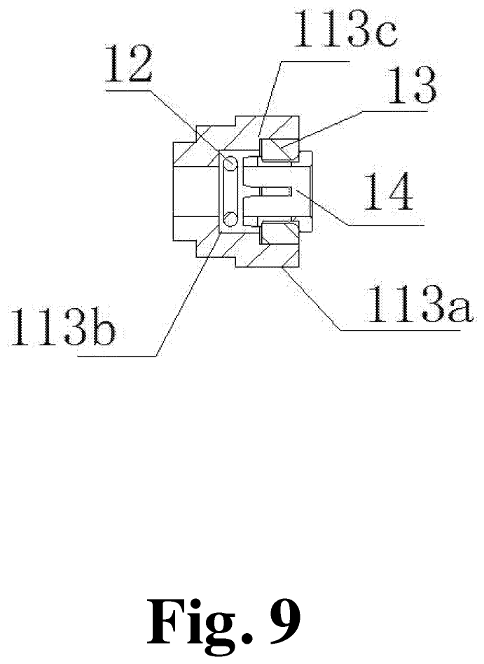

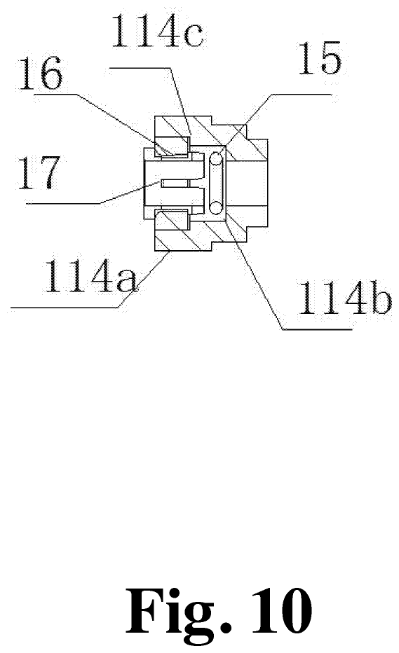

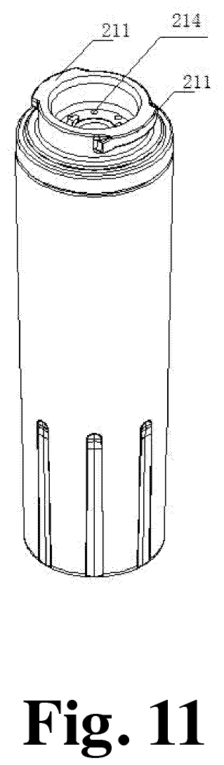

As shown in FIGS. 1-11, a single-stage filtration system comprises a joint 1 and a filter element 2, wherein the joint 1 is mounted on the filter element 2, the joint 1 comprises a joint body 11, a water inlet sealing ring 12, a water inlet cover plate 13, a water inlet clamp 14, a water outlet sealing ring 15, a water outlet cover plate 16, a water outlet clamp 17, a filter element inlet water sealing ring 18 and a filter element water outlet sealing ring 19, the joint body 11 comprises an inlet water cavity I 111, a water outlet cavity 112, a water inlet joint 113, a water outlet joint 114, a water inlet boss 116, a water outlet boss 117, a hanging piece 118, a reinforcing rib 119, the filter element 2 comprises an end cover 21, a filter element body 22, a carbon rod cover 23, a carbon rod bottom 24 and a carbon rod 25, the joint body 11 is provided thereon with the water inlet cavity I 111 and the water outlet cavity 112, one end of the water inlet cavity is the water inlet joint 113, the water inlet joint 113 is provided thereon with the water inlet boss 116, the water inlet boss 116 is cylindrical, and the water inlet hole 116a is at the center of the water inlet boss, one end of the water outlet cavity 11 is connected with the water outlet joint 114, the water outlet cavity 112 is located at an eccentricity of the water outlet boss 117, one end of the water outlet cavity 112 is connected with the water outlet joint 114, and the other end of the water outlet cavity 11 is on the water outlet boss, the water outlet boss is cylindrical, the water inlet joint 113 is provided therein with a water pipe hole I 113a, a sealing ring hole I 113b and a cover plate hole I 113c, the water pipe hole I 113a cooperates with a water pipe, the water inlet sealing ring 12 is mounted in the sealing ring hole I 113b, the water inlet cover plate 13 is mounted in the cover plate hole I 113c, the water outlet joint 114 is on the other side of the joint body 11, the water outlet joint 114 is provided thereon with a water pipe hole II 114a, a sealing ring hole II 114b, and a cover plate hole II 114c, the water pipe hole II 114c cooperates with the water pipe, the water outlet sealing ring 15 is mounted in the sealing ring hole II 114b, the water outlet cover plate 16 is mounted in the cover plate hole II 114c, the bottom of the joint body 11 is provided with two connecting flanges 11a, the connecting flange is a C-shaped structure, a rectangular opening 11b is provided above the connecting flange 11a, the connecting flange 11a cooperates with the end cover 21 of the filter element 2, the water inlet boss 116 is at the center of the filter element body 22, the water inlet boss 116 is formed into a column-shaped structure, one end of the water inlet boss 116 is connected with the joint body 11, and the other end of the water inlet boss 116 is connected with the water outlet boss 117, the water inlet boss 116 is provided therein with a water inlet passage 116a and a water outlet passage 116b, the water outlet passage 116b is located at the center of the water inlet boss 116, one side of the water outlet passage 116b is the water inlet passage 116a, the water inlet sealing ring 12 is mounted on the water inlet boss 116, the water outlet boss 117 is at the lower portion of the filter element body 22, the water outlet sealing ring 15 is mounted on the water outlet boss 117, the hanging piece 118 is located at the rear portion of the joint 1, the hanging piece 118 is provided thereon with four bosses 118a, the four bosses 118a are on the rear side of the hanging piece 118, the four bosses 118a are provided thereon with four through holes 118b, the carbon rod cover 23 is located at the upper end of the inner portion of the filter element body 22, the carbon rod cover 23 consists of a water inlet end 23a and a water outlet end 23b, the water inlet end 23a is an annular cylinder body, the inner cavity of the carbon rod cover 23 cooperates with the water outlet boss 117, and the other end of the carbon rod cover 23 is the water outlet end 23b, 5the carbon rod 25 is located at one end of the filter element body 22 and connected with the carbon rod cover 23, and the other end of the carbon rod 25 is connected with the carbon rod bottom 24.

Further, the water inlet boss 116 is provided thereon with a water inlet boss ring groove 116b, the water inlet sealing ring 12 is mounted on the water inlet boss ring groove 116, the water inlet boss ring groove 116 is arranged to facilitate the installation of the water inlet sealing ring 12 and achieve sealing.

Further, the water outlet boss 117 is provided thereon with a water outlet boss ring groove 117a, the water outlet sealing ring 15 is mounted on the water outlet boss ring groove 117a, and the water outlet boss groove 117a is arranged to facilitate the installation of the water outlet sealing ring 15 and achieve the sealing.

Further, the top of the end cover 21 has the flange 211, a central hole 212, a water inlet cavity II 213, the water inlet hole 214 and the stop port 215, one end of the flange 211 is located at the top of the end cover 21, and the other end of the flange 211 is located at the center of the end cover 21, the connecting flange 11a cooperates with the flange 211, the central hole 212 is located at the center of the end cover 21, an inner circle of the central hole 212 cooperates with and the outer circle of the carbon rod 23, the water inlet cavity II 213 cooperates with the water outlet boss 117, the water inlet hole 214 is located at the bottom of the water inlet cavity II 213, the stop port 215 has a concave structure, a convex stop port 22a in a barrel-shaped structure is above the filter element body 22, the stop port 215 and the convex stop port 22a are welded, the end cover 21 is arranged to achieve the connection of the joint 1 and the filter element 2 and facilitate installation and disassembly.

Further, the water inlet holes 214 are arranged and distributed in an annular shape in the outer circle of the center hole 212, the water inlet efficiency is improved by the arrangement of the plurality of water inlet holes 214.

Further, the water inlet cavity I 111 is L-shaped.

Further, the water outlet cavity 112 is L-shaped.

Further, a reinforcing rib 119 is arranged between the hanging piece 118 and the joint 2, and the strength of the joint is improved by the arrangement of the reinforcing rib 119.

Further, a connecting rib position 22b is arranged under the filter element body 22, and the carbon rod bottom 24 is mounted on the connecting rib position 22b, and the carbon rod bottom 24 is lifted by the arrangement of the connecting rib position 22b.

In the Invention, pre-filtration water enters the water inlet joint 113 via the water inlet end and then enters the water inlet passage 116a, and then enters the inner portion of the filter element through a filter element water inlet hole 214, and then the water needed to be filtered passes through the carbon rod 25 and becomes filtered water and reaches the central hole 212, and then purified water entering the filter element water outlet passage 116b via the central hole 212 enters the water outlet joint 114 to complete filtration. The installation and fixture are facilitated by the hanging piece 118, and the carbon rod cover 23 and the carbon rod bottom 24 are arranged to realize the positioning of the carbon rod 25.

Because the above technical solution is adopted, compared with the prior art, the Invention improves the wear of a connector caused by the repeated disassembly of a filter through the setting of the single-stage filtration system, and ensures the sealing performance of the filtration system.

The Invention is not limited to the above-described preferred embodiments, and any person skilled in the art should be aware of the structural changes made in the light of the Invention, any technical solution having the same or similar to that of the Invention belongs to the scope of protection of the Invention.

1. A single-stage filtration system, comprising a joint and a filter element, wherein the joint is mounted on the filter element, the joint comprises a joint body, a water inlet sealing ring, a water inlet cover plate, a water inlet clamp, a water outlet sealing ring, a water outlet cover plate, a water outlet clamp, a filter element inlet water sealing ring and a filter element water outlet sealing ring, the joint body comprises an inlet water cavity I, a water outlet cavity, a water inlet joint, a water outlet joint, a connecting flange, a water inlet boss, a water outlet boss, a hanging piece, a reinforcing rib, the filter element comprises an end cover, a filter element body, a carbon rod cover, a carbon rod bottom and a carbon rod, the joint body is provided thereon with the water inlet cavity I and the water outlet cavity, one end of the water inlet cavity is the inlet joint, the inlet joint is provided thereon with the water inlet boss, the water inlet boss is cylindrical, and the water inlet hole is at the center of the water inlet boss, one end of the water outlet cavity is connected with the water outlet joint, the water outlet cavity is located at an eccentricity of the water outlet boss, one end of the water outlet cavity is connected with the water outlet joint, and the other end of the water outlet cavity is on the water outlet boss, the water outlet boss is cylindrical, the water inlet joint is provided therein with a water pipe hole I, a sealing ring hole I and a cover plate hole I, the water pipe hole I cooperates with a water pipe, the water inlet sealing ring is mounted in the sealing ring hole I, the water inlet cover plate is mounted in the cover plate hole I, the water outlet joint is on the other side of the joint body, the water outlet joint is provided thereon with a water pipe hole II, a sealing ring hole II, and a cover plate hole II, the water pipe hole II cooperates with the water pipe, the water outlet sealing ring is mounted in the sealing ring hole II, the water outlet cover plate is mounted in the cover plate hole II, the bottom of the joint body is provided with two connecting flanges, the connecting flange is a C-shaped structure, a rectangular opening is provided above the connecting flange, the connecting flange cooperates with the end cover of the filter element, the water inlet boss is at the center of the filter element body, the water inlet boss is formed into a column-shaped structure, one end of the water inlet boss is connected with the joint body, and the other end of the water inlet boss is connected with the water outlet boss, the water inlet boss is provided therein with a water inlet passage and a water outlet passage, the water outlet passage is located at the center of the water inlet boss, one side of the water outlet passage is the water inlet passage, the water inlet sealing ring is mounted on the water inlet boss, the water outlet boss is at the lower portion of the filter element body, the water outlet sealing ring is mounted on the water outlet boss, the hanging piece is located at the rear portion of the joint, the hanging piece is provided thereon with four bosses, the four bosses are on the rear side of the hanging piece, the four bosses are provided thereon with four through holes, the carbon rod cover is located at the upper end of the inner portion of the filter element body, the carbon rod cover consists of a water inlet end and a water outlet end, the water inlet end is an annular cylinder body, the inner cavity of the carbon rod cover cooperates with the water outlet boss, and the other end of the carbon rod cover is the water outlet end, the carbon rod is located at one end of the filter element body and connected with the carbon rod cover, and the other end of the carbon rod is connected with a carbon rod bottom.

2. The single-stage filtration system according to claim 1, wherein the water inlet boss is provided thereon with a water inlet boss ring groove, and the water inlet sealing ring is mounted on the water inlet boss ring groove.

3. The single-stage filtration system according to claim 1, wherein the water outlet boss is provided thereon with a water outlet boss ring groove, and the water outlet sealing ring is mounted on the water outlet boss ring groove.

4. The single-stage filtration system according to claim 1, wherein the top of the end cover has a flange, a central hole, a water inlet cavity II, a water inlet hole, and a stop port, one end of the flange is located at the top of the end cover, and the other end of the flange is located at the center of the end cover, the connecting flange cooperates with the flange, the central hole is located at the center of the end cover, an inner circle of the central hole cooperates with an outer circle of the carbon rod, the water inlet cavity II cooperates with the water outlet boss, the water inlet hole is located at the bottom of the water inlet cavity II, the stop port has a concave structure, and a convex stop port in a barrel-shaped structure is above the filter element body, wherein the stop port and the convex stop port are welded.

5. The single-stage filtration system according to claim 4, wherein the water inlet holes are arranged and distributed in a circular shape in the outer circle of the central hole.

6. The single-stage filtration system of claim 1, wherein the water inlet cavity I is L-shaped.

7. The single-stage filtration system of claim 1, wherein the water outlet cavity is L-shaped.

8. The single-stage filtration system of claim 1, wherein a reinforcing rib is provided between the hanging piece and the joint.

9. The single-stage filtration system according to claim 1, wherein the filter element body is provided with a connecting rib position underneath, and a carbon rod bottom is mounted on the connecting rib position.
